(19) United States
(12) Patent Application Publication
(10) Pub. No.: US 2006/0181886 A1
(43) Pub. Date: Aug. 17, 2006

(54) Light stick conveying apparatus

(76) Inventor: Wills LaCrosse, Duluth, GA (US)

Correspondence Address: WELSH & FLAXMAN LLC, 2000 DUKE STREET, SUITE 100, ALEXANDRIA, VA, 22314, US

(21) Appl. No.: 11/059,540

(22) Filed: Feb. 17, 2005

(51) Int. Cl. F21V 21/34

(52) U.S. Cl. 362/385; 362/96; 362/233

(57) ABSTRACT

A lighting system includes an elongated tubular member, an illuminating member positioned within the tubular member for movement therein and a propulsion system associated with the tubular member causing the illuminating member to move within tubular member.

### BACKGROUND OF THE INVENTION

1. Field of the Invention

The invention relates to an illumination device. More particularly, the invention relates to an illumination device providing for the movement of light sticks through a transparent tubular member oriented in a predetermined design.

2. Description of the Prior Art

Lights are used by a multitude of industries to enhance and focus attention. For example, the entertainment industry uses special lighting in shows, plays, concerts, nightclubs, sporting events and the like. The lighting systems are highly developed and are commonly designed to coordinate with, and enhance, the entertainment value of the product.

The sign industry also utilizes lighting, in particular, sequenced lighting to convey motion to billboards, marquees, and monument signs. The signs are utilized to advertise for the specific business and, as such, the motion offered by these signs is used in attracting people's attention to the signs and conveying information. Sequenced lighting is also used in safety applications to direct individuals along a proper path. Blimps and other apparatuses also use sequenced lighting to spell out words and messages to viewers below.

Currently, the source of most lighting is derived from electricity. In the case of sequenced LED, incandescent or neon lighting, each of the individual lights must be connected to a source of electricity and controlled, in many instances, by a highly complicated control system. Some of these devices also require very high voltage power supplies. In addition, most current light sources emit substantial heat, which in some cases is an undesirable condition.

As such, it is desired to provide a moving light source which does not require a connection to electricity. It is known that chemiluminescent light sources offer an alternate light source not requiring electricity. Chemiluminescent light sources differ in that the chemical energy contained within a housing is converted directly to light without the creation of heat as a byproduct. They are especially useful because they do not generate heat, do not cause fires or explosions and they are bright and last for many hours.

The present invention attempts to overcome the shortcomings of prior electricity based light displays by providing a chemiluminescent or battery powered light source apparatus which provides moving light sources in a manner similar to that offered by standard electricity based devices.

### SUMMARY OF THE INVENTION

It is, therefore, an object of the present invention to provide a lighting system including an elongated tubular member, an illuminating member positioned within the tubular member for movement therein and a propulsion system associated with the tubular member causing the illuminating member to move within tubular member.

It is also an object of the present invention to provide a lighting system wherein the illuminating member is a glow stick.

It is another object of the present invention to provide a lighting system wherein the glow stick includes a seal.

It is a further object of the present invention to provide a lighting system wherein the glow stick includes a protective sleeve.

It is also another object of the present invention to provide a lighting system wherein the illuminating member is an electrically powered device.

It is still another object of the present invention to provide a lighting system wherein a plurality of illuminating members are positioned within the tubular member.

It is yet another object of the present invention to provide a lighting system wherein the propulsion system includes compressible or incompressible fluids.

It is a further object of the present invention to provide a lighting system wherein the propulsion system means includes an air compressor linked to the tubular member.

It is also a further object of the present invention to provide a lighting system wherein the propulsion system includes a booster system with a first valve and a second valve.

It is also an object of the present invention to provide a lighting system wherein the first and second valves are check valves.

It is another object of the present invention to provide a lighting system wherein the first and second valves are ball valves.

It is also another object of the present invention to provide a lighting system wherein the first valve and the second valve are selectively linked to a pressure source.

It is still a further object of the present invention to provide a lighting system wherein the first valve and second valve selectively switch between functioning as an exhaust port and a high pressure port.

It is yet a further object of the present invention to provide a lighting system including a loading device for inserting illuminating devices within the tubular member.

It is also an object of the present invention to provide a lighting system including a removing device for removing illuminating devices from the tubular member.

It is another object of the present invention to provide a lighting system including a splitting device for switching between sections of the tubular member.

It is also another object of the present invention to provide a lighting system including a joining member for linking sections of the tubular member.

It is yet another object of the present invention to provide a lighting system including a spinner device for spinning the illuminating member.

It is still a further object of the present invention to provide a lighting system including a brake system for controlling speed or travel of the illuminating members.

It is also an object of the present invention to provide a lighting system including a control assembly.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 2 is a schematic of a more elaborate lighting system in accordance with the present invention.

FIGS. 3, 4 and 5 disclose various embodiments of the glow sticks utilized in accordance with the present invention.

FIG. 6 is a schematic of an electronic battery powered glow stick.

FIGS. 7 and 8 are cross-sectional views of alternate tube sections which may be utilized in accordance with the present invention.

FIG. 9 is a cross-sectional view along the line 9-9 in FIG. 1.

FIG. 10 is a cross-sectional view of a removing device in accordance with the present invention.

FIG. 11 is a schematic showing the propulsion system.

FIGS. 12 through 17 are various views showing a connecting member utilized in linking adjacent tube sections.

FIG. 18 is a schematic of a water-based propulsion system.

FIGS. 19 and 20 are cross-sectional views of a ball valve in accordance with the present invention.

FIG. 21 is a cross sectional view of a swing check valve in accordance with the present invention.

FIG. 22 is a schematic of an alternate propulsion system in accordance with the present invention.

FIGS. 23, 24 and 25 ate schematics showing the propulsion system employed in accordance with the present invention.

FIG. 26 is a schematic of an automatic loading/unloading device.

FIG. 27 is a schematic of a braking system.

FIG. 28 is a schematic of a joiner device.

FIG. 29 is a schematic of a splitter device.

FIGS. 30, 31 and 32 are schematics of spinner devices.

FIG. 33 is a schematic showing a spinner device, splitter device and joiner device used in conjunction.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

With reference to FIG. 1, the present invention provides a lighting system 10 composed of an elongated tubular member 12, an illuminating member 14 positioned within the tubular member 12 for movement therein and a propulsion system 16 associated with the tubular member 12 causing the illuminating member 14 to move within the tubular member 12. The tubular member 12 is generally composed of a plurality of tube sections 18 linked together in a manner discussed below in greater detail. The tubular member 12 is at least translucent, and preferably transparent, to permit viewing of the illuminating member 14 moving within the tubular member 12.

In particular, and in accordance with a preferred embodiment of the present invention, a plurality of illuminating members 14 are used in conjunction with the present lighting system 10. The illuminating members 14 may be traditional chemilunminescent glow sticks known to those skilled in the art or self contained, electrically powered light sticks as described below in greater detail. However, other equivalent illuminating members may be used without departing from the spirit of the present invention.

Referring to FIG. 6, a battery powered glow stick 14′ is disclosed in accordance with the present invention. The battery powered glow stick 14′ includes a translucent or transparent housing 14b′ in which a plurality of LEDs 19 are housed. The LEDs 19 are coupled to and powered by a series of batteries 17 stored within the housing 14b′. In this way, the LEDs 19 may be powered and illuminated for extended periods without worrying that their illumination power will diminish. The batteries 17 are inserted via a removable end cap 14a′ and the LEDs 19 are linked to the batteries via a printed circuit board 13. Although glow sticks of various constructions may be used in accordance with the present invention, for purposes of brevity only chemiluminescent glow sticks 14 will be discussed for the remainder to the specification.

The glow sticks 14 are conveyed through the tubular member 12 by establishing a pressure differential across the tubular member 12. Air, water, or other liquids or gases, are used as a conveying medium in the tubular member 12. In accordance with a preferred embodiment as described herein, compressed air is used as a pressure source within the present lighting system 10. The compressed air is provided by an air compressor 20 linked to the lighting system 10 in a manner described below in greater detail.

As best seen in FIGS. 3 through 5, each of the glow sticks 14 includes a back end 22 and a front end 24. During operation, the propulsion system 16 creates a pressure build-up with a high-pressure zone adjacent the back end 22 of the glow stick 14 and a low-pressure zone adjacent the front end 24 of the glow stick 14. The pressure differential between the front end 24 and the back end 22 of the glow stick 14 causes the glow stick 14 to move within the tubular member 12. As those skilled in the art will certainly appreciate, the pressure differential may be varied to control the speed with which the glow stick 14 moves through the tubular member 12.

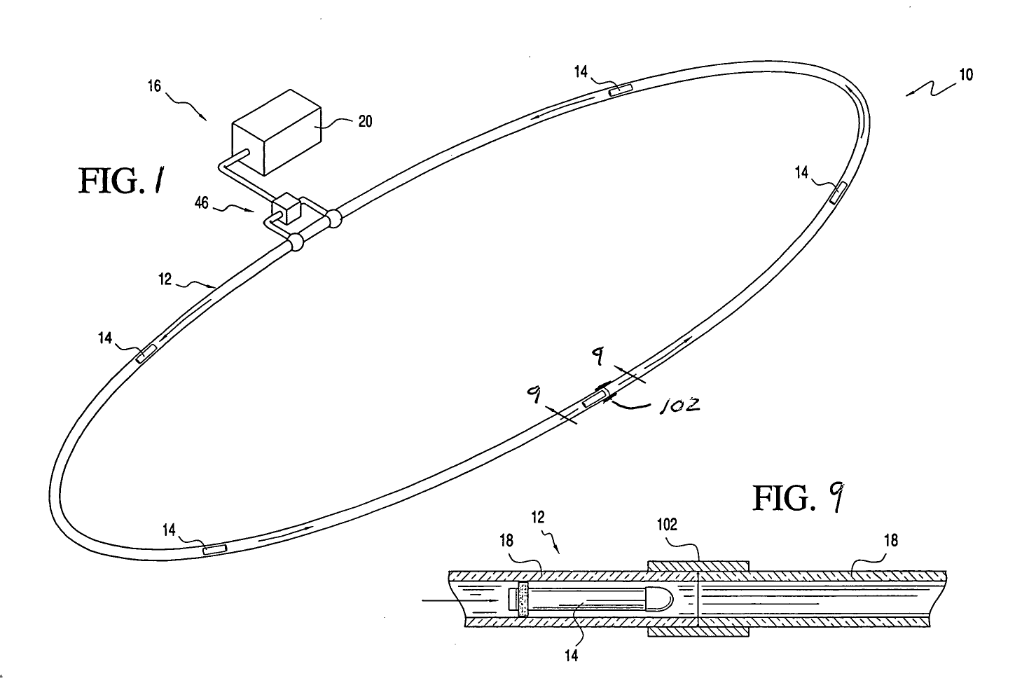

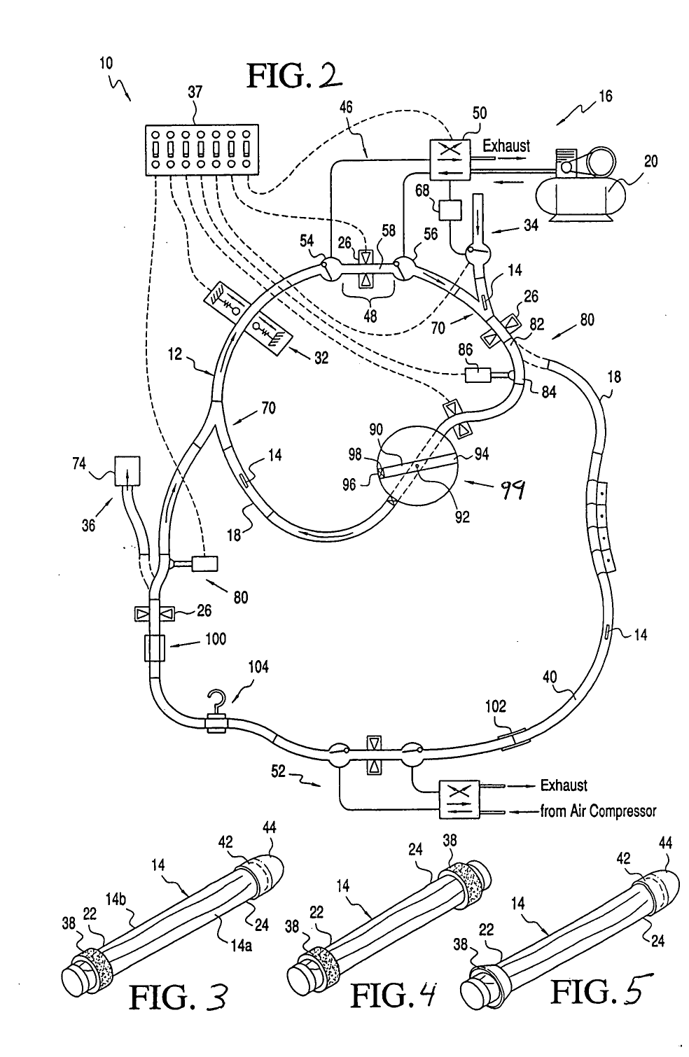

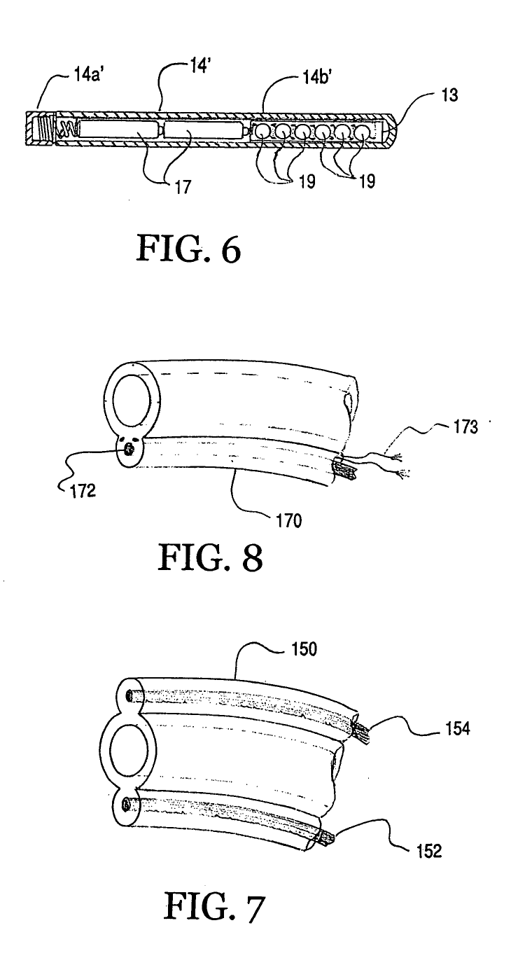

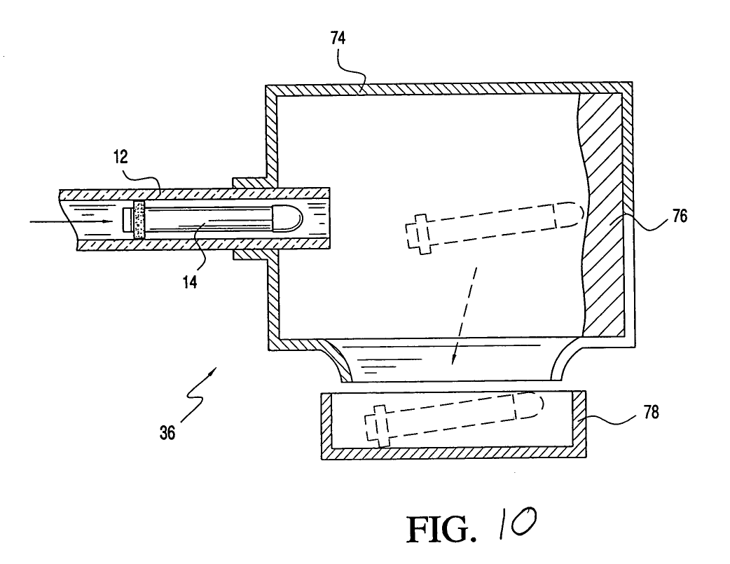

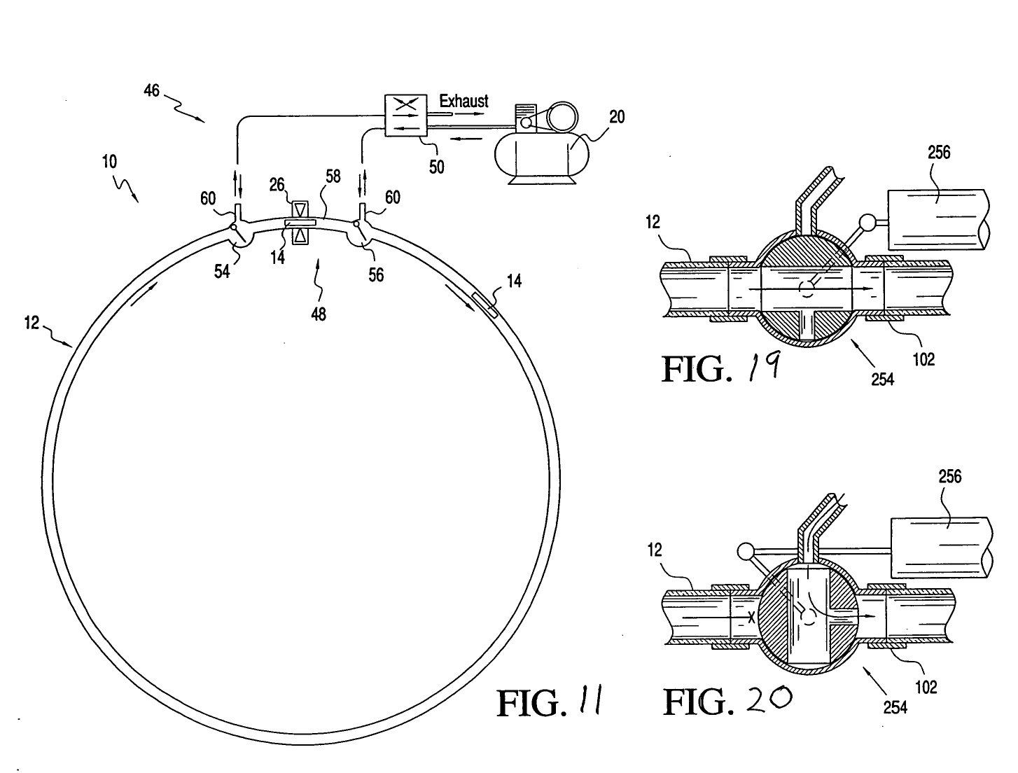

In accordance with preferred embodiments of the present invention, and as shown in FIG. 2, the basic elements of the lighting system 10, that is, the tubular member 12 and the propulsion system 16, are supplemented with various components designed to enhance operation thereof and to enhance the visual experience offered by the present system 10. For example, switches 26, splitter devices 80 and joining members 70 are employed to join or split paths created by the tubular member 12. A brake system 32 is employed to sequence or stop the glow sticks 14 in a controlled manner, and loading devices 34 and removing devices 36 are provided for facilitating the addition and/or removal of glow sticks 14 from the lighting system 10.

Further, the lighting system 10 employs a control assembly 37 for directing and monitoring the movement of the glow sticks 14 through the tubular member 12 of the lighting system 10, while also activating and communicating with various devices and sensors positioned along the lighting system 10. The control assembly 37 is electrically linked to the various components of the lighting system 10 and includes a microprocessor for controlling the various components in a highly effective manner.

As discussed above, the present device employs an elongated tubular member 12 as a conduit for the glow sticks 14. The elongated tubular member 12 may take a variety of shapes and forms without departing from the spirit of the present invention. Standard transparent tubing in various length rolls can be found at industrial supply houses and at most hardware stores. However, care must be exercised when using standard tubing to ensure that a sufficient bend radius is maintained to allow the glow sticks 14 to travel without binding. That is, the bend radius of the tubular member 12, when laid out as a track in a particular lighting system configuration, must be of a sufficient radius to insure the glow stick will be able to navigate around the loop without sticking or binding. Special tubing with a flexible wire molded in the tubing material will prevent undesirable reductions in the bend radius and serve to support the tubing. Additionally, the wires may also serve as control wires for activating electrical devices and sensors needed along the tubing path.

With this in mind, special tubing 150 or 170 as shown in FIGS. 7 and 8, respectively, could be used. The tubing 150 (see FIG. 7) is made with a pair of flexible wires 152, 154 molded therein and the tubing 170 (see FIG. 8) includes one flexible wire 172 and separate control wires 173. The wires 152, 154, 172 would function to not only maintain the shape of the tubular member 12, but also as a signal or current carrying conductor. The wires 152, 154, 172, 173 could be used to control various electrical components and sensors used with the invention as discussed above. The wires 152, 154, 172,173 can carry electrical signal data from photo-electric devices, which are able to provide data concerning the speed of the glow sticks, direction and location along the path of travel, installed at critical points along the lighting system 10. Each device connected to the wire or wires 152, 154, 172, 173 would have an individually addressable identifier code permitting the microprocessor to communicate with each of the devices individually or as a group via command signals sent, received and responded to by the devices.

With reference to FIGS. 3 through 5 and regarding the glow sticks 14, conventional glow sticks commonly known to those skilled within the industry can be utilized. In accordance with a preferred embodiment of the present invention, the glow sticks 14 are modified to enhance movement within the tubular member 12 and to enhance the wear characteristics of the glow sticks 14 and the tubular member 12. In particular, a thin strip of felt or other material (for example, rubber, nylon, thin plated metal, or PTFE material) is attached to either end of the glow stick to provide a pressure seal 38, restricting the transport medium of the propulsion system 16 from flowing past the glow stick 14. This provides an effective pressure differential along its length, as greater pressure will be sustained behind the glow stick 14. The pressure seal 38 is provided such that the diameter of the glow stick 14, including the pressure seal 38, is only slightly smaller than the internal diameter of the tubular member 12. The diameter of the seal 38 is determined by balancing the friction created by the seal 38 with the desired tightness of the seal 38 against the tubular member's inner wall. Those skilled in the art will appreciate the mechanics associated with optimizing such a design. It is contemplated that seal 38 should maximize sealing, minimize wall friction and provide protection against the tubing internal wall 40 contacting the glow stick 14 to ensure the longest stick and tubing life with the most efficient thrust ratio. As seen in FIG. 5, the strip 38 may be tapered thus minimizing the contact area between the internal tubing wall 40 and the strip 38.

It has been found the back end 22 and the forward end 24 of the glow sticks 14 will wear as they move through the tubular member 12 and rub against the internal tubing wall 40 of the tubular member 12. This shortens the life of the glow sticks 14 as the erosion from rubbing against the tubular member 12 exposes the liquid 14a within the housing 14b of the tubular member 14. The life of a glow stick 14 is also shortened as a result of impact from other glow sticks 14 passing through the tubular member 12 and contact with the control mechanisms of the lighting system 10. This contact can lead to the erosion of the housing 14b of the glow stick 14 resulting in the release of the liquid 14a contained within the housing 14b.

To extend the life of the glow stick 14, the tip 42 is covered by a metal, TEFLON, nylon, or other suitable material, via a sleeve 44 that provides erosion and collision protection for the soft plastic of the glow stick housing 14b (see FIGS. 3 and 5). It is further contemplated that the back end 22 of the glow stick may also be covered to enhance operation of the apparatus in accordance with the present invention. In accordance with a preferred embodiment, the metal sleeve 44 is fairly blunt and is designed to fit tightly over the tip 42 of the glow stick 14. In accordance with a preferred embodiment, the metal sleeve 44 may be secured by solvent, glue, crimping or interference fit.

While modified glow sticks are disclosed for use in accordance with a preferred embodiment of the present invention, a variety of glow sticks, both modified and unmodified, as well as equivalent illuminating devices, for example, self-contained powered LED devices, may be employed without departing from the spirit of the present invention.

As best seen in FIG. 9, the tubular member 12 is commonly composed of a plurality of tube sections 18 linked in a desired manner by tubing connectors 102 to create a tubular member 12 through which the glow sticks 14 may freely move. A connector 102 in the form of a friction fit sleeve is desired when standard tubing is employed. The tubing connectors 102 allow one to connect tube sections 18 together to create a very long and intricate tubular member 12.

As those skilled in the art will certainly appreciate, standard tubing can be utilized in accordance with the present invention. When using standard tubing, however, care must be exercised to ensure a sufficient radius is maintained for allowing glow stick travel. This is often difficult when setting up the system.

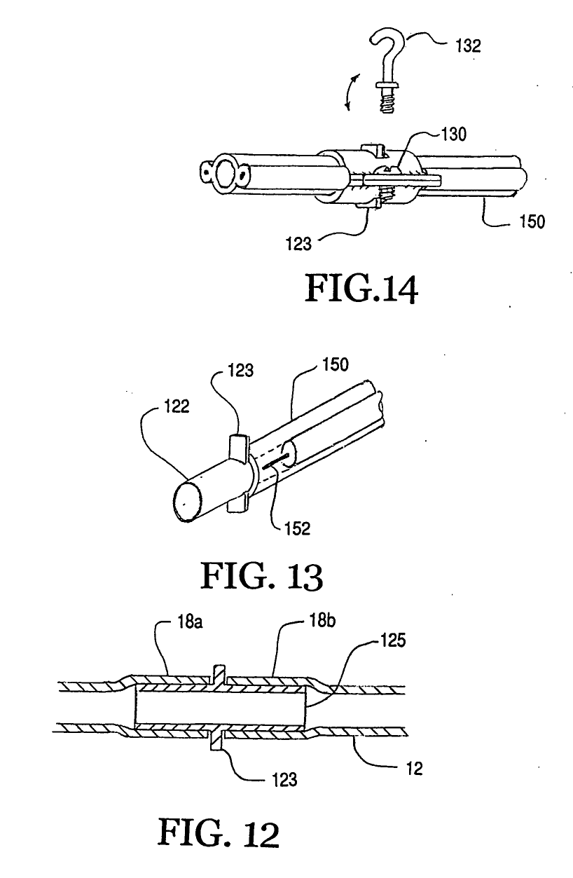

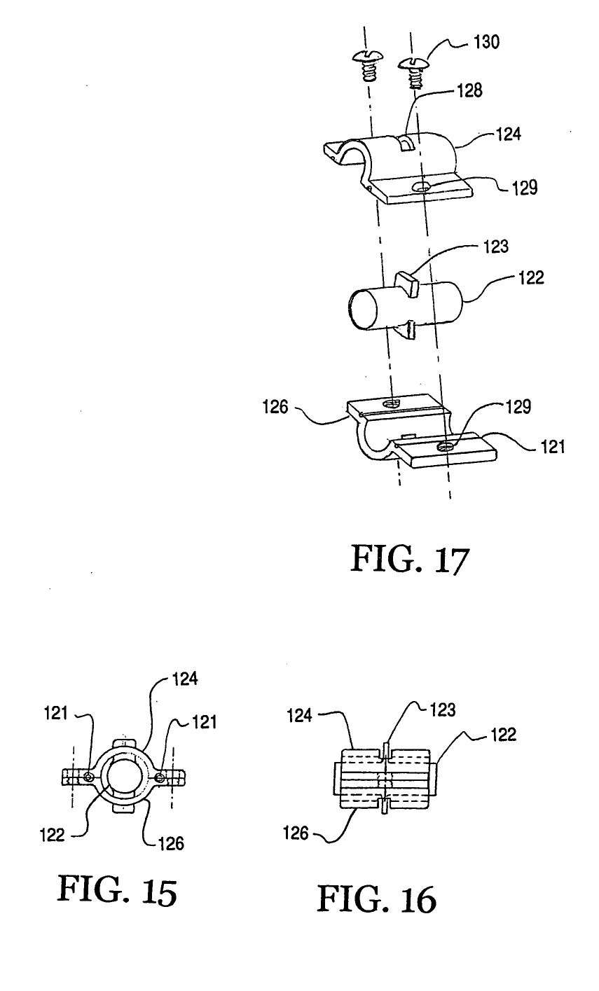

If tubing with molded wire or wires as discussed above is employed, a connector 120 shown in FIGS. 12 through 17 must be used. The disclosed connector 120 includes a sleeve 122 with tabs 123, an upper cover 124 and a lower cover 126. The upper and lower covers 124, 126 are connected to one another by screws 130 and/or 132 trapping the sleeve 122 and tubing ends 18a, 18b therebetween. Before joining the tubing ends 18a, 18b a length of the wire 152 must be exposed such that it can be spliced during assembly (see FIG. 13).

To join tube sections 18a, 18b, made from tubing 150 (see FIG. 7), together using the connecter 120, the sleeve 122 is inserted into the respective ends of the tube sections 18a, 18b thereby stretching and enlarging the diameter of the tubing ends as shown in FIG. 12. Even though the sleeve 122 is inserted into the tube sections 18, its internal diameter is slightly larger than the internal diameter of the tube sections 18 thus the glow sticks 14 pass through the connection point without contacting the sleeve end 125. The upper and lower covers 124, 126 include slots 128 which are then placed over the tabs 123 in a manner aligning the screw holes 129. The covers include metal inserts 121 which splice the wire ends together when pinched between the flanges of the covers 124, 126. Screws 130 or 132 to provide a hanging support are then threaded through screw holes 129 sandwiching the sleeve 122, tubing ends 18a, 18b and wires therebetween as shown in FIG. 14.

In addition, the elongated tubular member 12 may be accessorized with various control mechanisms that will be discussed below in greater detail. The propulsion system 16 propels the glow sticks 14 through the tubular member 12. In accordance with a preferred embodiment, and as seen in FIGS. 1 and 11, a main propulsion system 46 is provided. The main propulsion system 46 creates high-pressure behind the glow stick 14. The high-pressure is forced within the tubular member 12 at a predetermined boost area 48. The pressure differential propels the glow stick 14 through the tubular member 12. With the tubing of the tubular member 12 arranged in a closed loop, the glow stick 14 will soon return to the initial boost area 48 and be propelled through the tubular member 12 again and again until the glow stick 14 is removed.

The main propulsion system 46 generally operates through the selective creation of an exhaust port and a high-pressure source or port. In accordance with a preferred embodiment, the main propulsion system 46 is powered by an air compressor 20 selectively linked to the exhaust port and the high-pressure port via a 4-way solenoid valve 50. The main propulsion system 46 is designed to allow the glow stick 14 to travel past the exhaust port and back to the other side of the high-pressure port where a high-pressure load is created along the back end 22 of the glow stick 14. Where the tubular member 12 requires that the glow stick 14 traverse a longer path, an inline booster system 52, similar to the main propulsion system 46 described herein may be provided to ensure that the glow stick speed or travel progress is maintain throughout the entire path of the tubular member 12 (see FIG. 2).

The main propulsion system 46 is best suited for use when multiple glow sticks 14 are inserted into the same tubular member 12. As those skilled in the art will appreciate, one loop might have ten to twenty glow sticks 14 all circulating and each glow stick 14 must be appropriately propelled.

For the purpose of describing the main propulsion system 46 of the present lighting system 10, FIG. 11 shows a basic continuous loop propelling system with a main propulsion system 46. As briefly discussed above, the continuous loop propelling system requires that the main propulsion system 46 sense where the glow sticks 14 are positioned such that high-pressure and low-pressure areas may be appropriately created in relation to the moving glow sticks 14.

First and second check valves 54, 56 (or modified ball valves) are controlled by the solenoid valve 50 connected to the air compressor 20 as discussed above. The first and second valves 54, 56 selectively function as the exhaust port and the high pressure port under the control of the solenoid valve 50, with the first valve 54 primarily functioning as the exhaust port and the second valve 56 primarily functioning as the high pressure port.

The main propulsion system 46 works in a manner similar to an air lock on a spacecraft or water locks on canals for ships. That is, to get the ship from a lower level (low pressure) to the higher level (high pressure side), the ship enters a contained zone where the level is increased to match or slightly exceed the higher level. The present main propulsion system 46 does the same thing to get the glow stick 14 back to the high pressure side after circulating in its loop. In general, the glow stick 14 enters an isolation area 58 isolated by the first and second valves 54, 56. A switch 26 positioned between the first valve 54 and the second valve 56 senses the glow stick 14 within the isolation area and instructs the solenoid valve 50 to reverse the input and output pressure connections to the first and second valves 54, 56 (that is, switches the exhaust port and the high pressure port) for a brief period of time to convey the glow stick 14 through the isolation area 58 to the other side of the second valve 56; a high pressure zone is created within the first valve 54 and a low pressure zone is created within the second valve 56. With this momentary change in pressure, the glow stick 14 is moved through the isolation area 58 between the first and second valves 54, 56, passing through the second valve 56. As the momentum of the glow sticks 14 allows it to clear past the second valve 56, the pressure is switched back to normal with high pressure coming from the second valve 56 and a low pressure exhaust coming from the first valve 54.

More particularly, the glow stick 14 is placed within the tubular member and the first and second valves 54, 56 allow the glow stick 14 to pass through them. Each valve 54, 56 has a side tap 60 allowing input or output of the conveying medium, for example, air. The side tap 60 is located only on the discharge side of the first and second valves 54, 56. The switch 26 located between the first and second valves 54, 56 detects when a glow stick 14 enters the isolation area 58 between the first and second valves 54, 56. In accordance with a preferred embodiment, modified ball valves or swing check valves (as discussed below) are used. In practice, the valves are separated to a distance to provide for a smooth transition through the main propulsion system 46.

In use, and assuming the direction of the glow stick 14 travel is clockwise within the loop of the tubular member 12 with the first and second valves 54, 56 installed at the top of the loop, with the glow stick 14 placed in the tubular member 12 to the right of both the first and second valves 54, 56, the glow stick 14 is conveyed through the tubular member 12 under the high pressure supplied through the second valve 56 and the low pressure (exhaust) offered by the first valve 54. The glow stick 14 then circulates clockwise in the loop and approaches the first valve 54. As the glow stick 14 travels through and past the first valve 54, it is driven only by its momentum since it has traveled past the first valve 54 acting as the exhaust port. As the glow stick 14 slows, it will pass and activate the switch 26. Activation of the switch 26 activates the timing solenoid valve 50 to temporarily reverse the input and output functions of the first and second valves 54, 56. This switch causes the first valve 54 to momentarily function as the high pressure port and the second valve 56 to momentarily function as the exhaust port or low pressure source. This action propels the glow stick 14 past the second valve 56. As it now clears the second valve 56, it passes the exhaust port (that is, the second valve 56 as it is still functioning as the exhaust port) and will begin to slow as no pressure is now moving it forward with propulsion primarily due to its forward momentum past the second valve 56. The glow stick 14 has now returned to its initial starting position. The cycle is repeated by setting the timing of the solenoid valve 50 to time out and returning the input and output functions of the first and second valves 54, 56 to their original configurations with the first valve 54 functioning as the exhaust port and the second valve 56 functioning as the high pressure port. The glow stick 14 is now accelerated around the loop as before.

As discussed above, the first and second valves 54, 56 are either ball valves or check valves. One advantage of utilizing ball valves as described herein is that the glow sticks have better guidance when passing through the valves. When using a check valve, the glow stick is often misguided as it flows past the swing flapper area. A disadvantage of ball valves is that they must be actuated by additional equipment, whether it is electronically, manually, pneumatically, or hydraulically, while the check valve system offers automatic switching without the additional equipment requirements. Further, the check valves described above provide a simpler system, but they are prone to leak past the valve seats. The modified ball valves are leak free, but require more equipment. Those skilled in the art will appreciate the system requirements will dictate which valves are to be used.

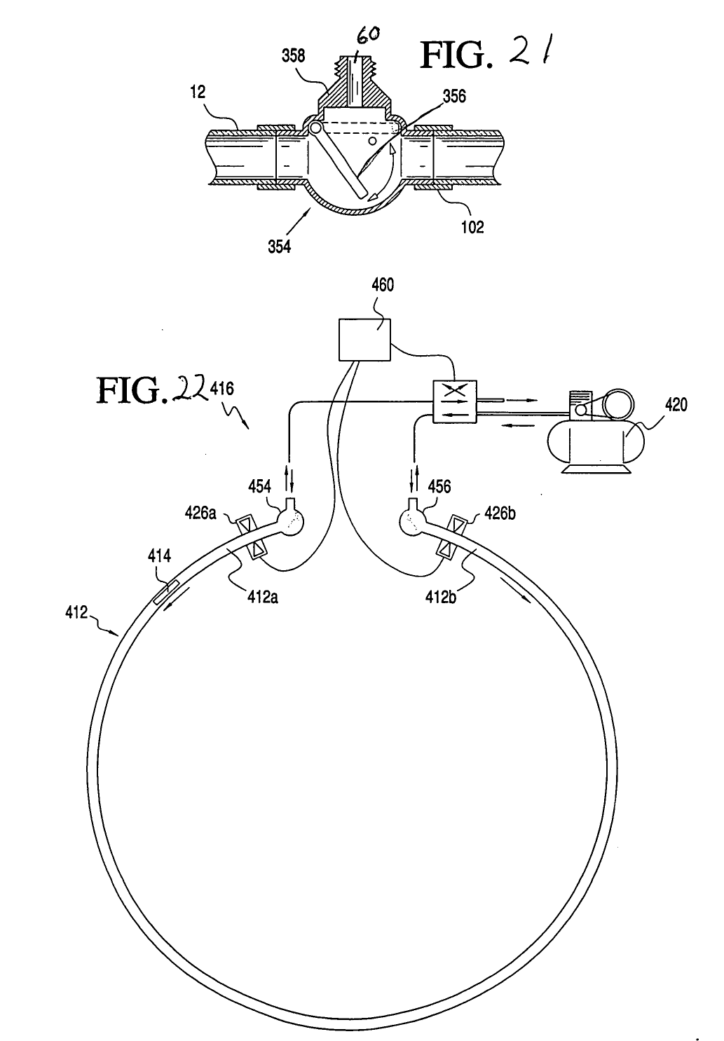

In an effort to improve upon the functionality of the present system, modified valves may be used. In accordance with a first embodiment, and with reference to FIGS. 19 and 20, the modified ball valve 254 requires an air cylinder 256 to rotate the valve 254 for opening and closing the same to permit the passage of the glow stick therethrough. The valve 254 may be further modified by adding an input/output port in the side of the valve body. Although a preferred embodiment is described above, it is contemplated they may also be used unmodified with the exhaust/pressure port located immediately past the valve as a separate fitting.

In accordance with a further embodiment of the present invention, and with reference to FIG. 21, a swing check valve 354 may be utilized. This embodiment requires that the swing check 356 be ground to reduce its mass and to allow a full port opening. In addition, the bonnet 358 (that is, the top part of the valve on the discharge side) is tapped to provide the input/output connection 60. By utilizing this design, the pressure/exhaust port functions better since it is located directly on the check valve 354. With reference to FIG. 22, a propulsion system 416 for a single glow stick 414 reversing embodiment is shown and described. In accordance with this embodiment, the propulsion system 416 uses an air compressor 420 linked to first and second ends 412a, 412b of the tubular member 412. The air compressor 420, in a controlled manner, applies high pressure and exhaust to the respective ends of the tubular member 412 causing the glow stick 414 to reverse direction in a controlled manner. Two switches 426a, 426b (or one switch sensing both lines coupled with a flip flop circuit) are used to identify the location of the glow stick 414 and control switching of the pressure and exhaust supplied by the air compressor 420. The first and second switches 426a, 426b are respectively placed before first and second valves 454, 456 associated with the first and second ends 412a, 412b of the tubular member 412. As the glow stick 414 approaches either the first or second valve 454, 456, the switch 426a, 426b engages the control logic 460 to automatically reverse the input/output valve function to send the glow stick 414 in the opposite direction.

As briefly discussed above, the present invention provides a mechanism for loading and removing glow sticks 14 from within the tubular member 12. The loading device 34 or removing device 36 may be a supplemental feature added to the main propulsion system 46 or tubular member 12 in that they allow easy input and removal of glow sticks 14 from the tubular member 12.

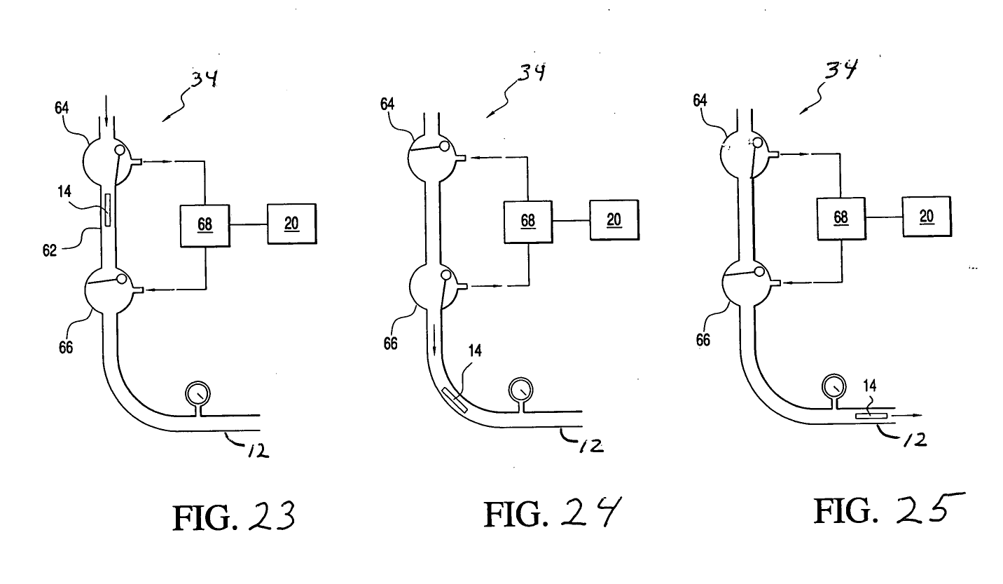

In accordance with a first embodiment, and with reference to FIGS. 23 through 25, a simple loading device 34 allows an operator to load a glow stick 14 in a manner substantially similar to that employed in accordance with the main propulsion system 46. The loading device 34 allows an individual to drop the glow stick 14 into a staging area 62 between first and second loading valves 64, 66 and control release of the glow stick 14 into the tubular member 12 by selectively pressurizing the first and second loading valves 64, 66 as either an exhaust port or a high pressure port under the control of the air compressor 20 and a solenoid valve 68. As the glow stick 14 is initially loaded within the loading device 34, the first loading valve 64 functions as an exhaust port while the second loading valve 66 functions as a high pressure port. Once the glow stick 14 is positioned within the staging area 62 between the first and second loading valves 64, 66, a manual switch (not shown) is used to activate the solenoid valve 68 to reverse the function of the first and second loading valves 64, 66. This causes the glow stick 14 to be released from the staging area 62 into the tubular member 12. This action propels the glow stick 14 past the second loading valve 66. As the glow stick 14 clears the second loading valve 66, it passes the exhaust port (that is, the second loading valve 66 is still function as the exhaust port) and will begin to slow as no pressure is moving it forward. The functions of the first and second loading valves 64, 66 are returned to normal by manually actuating the solenoid valve 68 to return the input and output functions of the two loading valves 64, 66 to their original configurations with the first loading valve 64 functioning as the exhaust port and the second loading valve 66 functioning as the high pressure port. The glow stick 14 is now accelerated within the tubular member 12. Merging of the incoming glow stick 14 is facilitated by using a joining member 70 to link loading device 34 to the tubular member 12.

To inspect looping glow sticks 14 already positioned in the tubular member 12, the glow sticks 14 are discharged from the tubular member 12 using a removing device 36 including a splitter device 80 which directs the glow sticks 14 to a retrieval area 74 (see FIGS. 2 and 10). The retrieval area 74 includes a damping member 76 designed to dissipate the glow stick momentum (for example, a hanging piece of leather, a piece of rubber or a foam block) as it enters a collection bin 78 where the operator may pick up the glow sticks 14, inspect their condition and place them into the loading device 34.

It is contemplated an automatic loading device/removing device may be provided. This would allow the operator to manually load new sticks into the system as discussed above, but allows the returning sticks to come to rest in the staging area directly instead of out of the system to an open bin. An automatic breaking device would be provided to slow the sticks and meter them efficiently into the staging area.

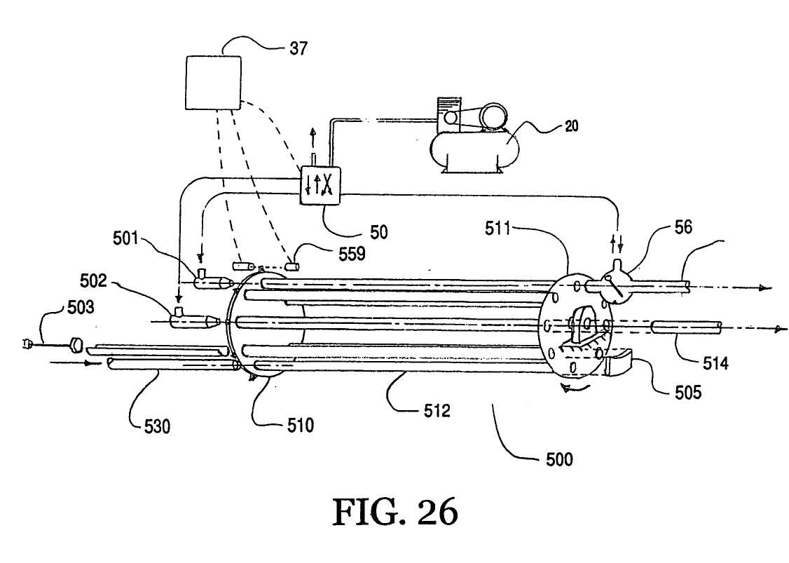

Referring to FIG. 26, an example of an automatic loading/unloading device 500 is disclosed. The automatic loading/unloading device 500 allows the operator to manually load new glow sticks 14 into the lighting system 10 and provides for the return of glow sticks 14. The returning glow sticks 14 come to rest in a staging area 510 as opposed to utilizing a collection bin 78 as previously discussed. The automatic loading device 500 requires the automatic braking device 32 to slow the sticks and meter them efficiently into the staging area 510. The braking device 32 slows, controls and/or stops the glow sticks on command via a compression mechanism.

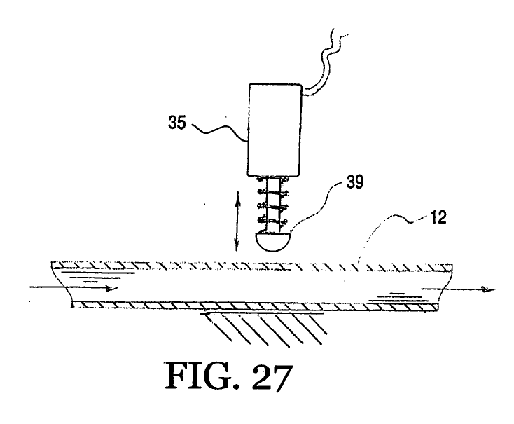

With reference to FIG. 27, the braking device 32 in accordance with the present invention is a simple device that pinches the outside of the tubing using an electric solenoid 35 or air cylinder. The force required to pinch the tubing is minimal. The glow stick 14 will stop when the internal diameter is pinched to a diameter smaller than that of the glow stick 14 causing the glow stick 14 to come into contact therewith and stop. The pinching occurs when the solenoid 35 receives current and is activated causing plunger 39 to extend and contact tubular member 12. The solenoid 35 is of the conventional magnetic type in that the magnet when energized repels the plunger 39. The braking device 32, in conjunction with electrical relays and switches 26, can be used to prevent collisions, space out back-to-back glow sticks 14, meter glow stick 14 progress at any point along the system, assure that only one glow stick 14 enters the booster area at a time and control the system in other related manners.

The automatic loading /unloading device 500 can replace the main propulsion system 46, the manual loader 34 and the unloader 36 discussed above. The brake 32 is still required to meter the glow sticks 14 into the system. The automatic loading/unloading device 500 operates in a manner similar to a “gatling gun”. That is, the device rotates a series of transparent tubes 512, which may contain a glow stick 14. As the transparent tubes 512 are rotated, they are stopped at precise alignment intervals with the incoming line 530 and then outgoing line 520 so the operator can inspect an incoming glow stick 14, unload if necessary, load a new glow stick 14 if necessary and shoot glow sticks 14 into the system. The valve 54 is not needed and is replaced by an air nozzle 501 in accordance with this embodiment. The glow stick return is always open to atmospheric pressure. The slow rotational speed allows the operator to inspect the condition of incoming glow sticks 14.

In accordance with this embodiment, the loading/unloading device includes a staging area 510 in the form of a drum 511 supporting plural transparent tubes 512. The drum 511 is rotated and stops at intervals by using switch 559 under command form control system 37 to align the incoming line 530 and outgoing line 520 paths with the clear tubes 512 on the drum 510. Once stopped, the air nozzle 501 can shoot a glow stick past valve 56 if it is reversed to function as an exhaust valve through the operation of the 4-way solenoid valve 50. At the same time, the return line is aligned to receive incoming glow sticks 14. When coming in, the glow sticks 14 will be stopped by a stop plate 505 after traveling into the clear tube 512 on the drum 511. The stop plate 505 is spaced slightly from the end of the drum 511 so as to not be in contact therewith. Another air nozzle 502, activated manually, is used to blow out damaged or worn glow sticks 14 to exit the system 10 through line 514and hand stick 503 is used to load a new glow stick 14 in an open tube 512 located on drum 511.

In practice, the drum rotates to allow the process to be continually repeated at each respective alignment interval. By alignment interval it is meant that the drum 511 is rotated one interval until each successive tube 512 aligns with outgoing line 520 using switch 559 controlled by system 37.

In addition to the various supplemental devices discussed above, the lighting system 10 may further be provided with a splitter device, a joiner device, a spinner device and a pulse pressure system.

Referring to FIG. 2, a splitter device 80 is disclosed. The splitter device 80 is similar to track switches for model trains and allows the glow stick 14 to be sent on command to another loop of a tubular member 12. The splitter device 80 also allows for interaction between adjacent and interconnected tubular members 12.

In accordance with a preferred embodiment, the splitter device 80 includes a first end 82 and a second end 84 with a single tube at the first end 82 selectively linked to two, or more, tubes at the second end 84. The first tube at the first end 82 is moved from alignment with the respective tubes at the second end 84 under the control of an air cylinder 86, or other actuating member. In addition, a switch 26 is provided adjacent the first end 82 of the splitter device 80 for sensing the presence of a glow stick 14.

Referring to FIG. 29, and in accordance with an alternate embodiment, a different splitter device 81 is disclosed. As with the prior splitter device 80, this splitter device 81 allows a glow stick 14 to be sent on command to another tubing loop. In general, the splitter device 81 includes a paddle 85 inside of a chamber 87. The paddle 85 directs an incoming glow stick 14 to one of the two or more outlets ports 88, 89 at end 84. An externally mounted electric solenoid 83 or an air cylinder directs the paddle to guide the glow stick to the proper outlet port 84 via a linkage system 95 connected between the solenoid 83 and paddle 85.

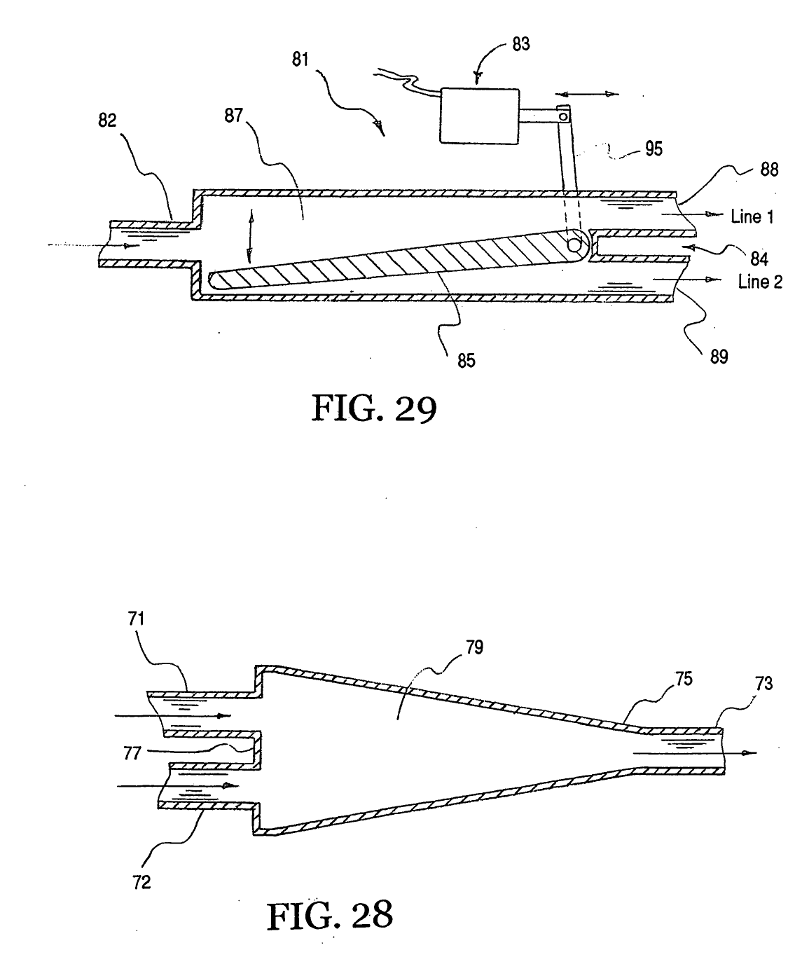

A joiner device 70 is disclosed with reference to FIGS. 2 and 28, the joiner device 70 brings glow tubes 14 within the tubular system 12 to a merged junction where two loops or tracks 71,72 merge into a single loop or track 73. The joiner device 70 is a static device similar to a rectangular funnel. The joiner device 70 channels incoming glow sticks 14 to one outlet. Two lines 71, 72 allow the glow sticks 14 to enter in the larger side 77 of a chamber 79. The momentum of the glow stick 14 will carry it through to the outlet on the other side 75 of the chamber 79. The driving air pressure is diminished once the glow stick 14 enters the large chamber area 79. The joining device 70 may be supplemented through the addition of a brake system 32 to either or both input lines 71,72 just before the joiner device 70. Such a brake system 32 will eliminate the potential of collisions if two glow sticks 14 enter at the same time.

In addition, a spinner device 99 may be provided (see FIG. 2). The spinner device 99 receives a glow stick 14, stops its linear motion and introduces a circular motion about a central point. After rotating in the circle, the spinner device 99 stops and the glow stick 14 is released to continue along its normal linear path.

The spinner device 99 is capable of altering the orientation and angle of spinning glow sticks 14 to produce a moving cone of light for any desired effect. The spinner device 99 may also be powered electrically or by available air pressure. The spin angle can be changed using natural centrifugal force regulated by the rotation speed or by actuators powered by air or electrical means.

When a glow stick 14 is spun around an axis, the light is perceived as a band of color by the naked eye. Depending on the rotation axis, the light appears as a tube of light, a circular band or a cone of light. The various spinner devices 99 in accordance with the present invention are designed to rotate the glow sticks 14 in any plane to achieve a desired visual effect. Additionally, it is contemplated the spinner device 14 will be able to vary the rotative speed and the axis plane in orientation while in operation. Such adjustments will provide an active light display. The spinner device 99 is designed to be used as a stand alone product as well and need not be connected to the present tubing system. Glow sticks 14 can be loaded into the spinner device 99 and spun to achieve the desired lighting affect.

More particularly, as shown in FIG. 2, the spinner device 99 includes a tube 90 mounted for rotation upon a pivot point 92. The tube 90 includes a first end 94 and a second end 96 with a valve 98 positioned at the second end 96. The valve 98 is controlled to selectively open and close the second end 96 for the free passage of the glow stick 14 therethrough. As a glow stick 14 passes into the tube 90, the valve 98 is closed and the glow stick 14 is, therefore, retained therein. With the glow stick 14 retained within the spinner device 99, the tube 90 is rotated about the pivot point 92 and stopped back in alignment with the adjacent tube sections of the tubular member 12. The valve 98 is then opened and the glow stick 14 is released to the tubular member 12. A switch 26 is provided near the first end 94 of the tube 90 for sensing the presence of a glow stick 14 and for providing instructions that the spinning process should be begin.

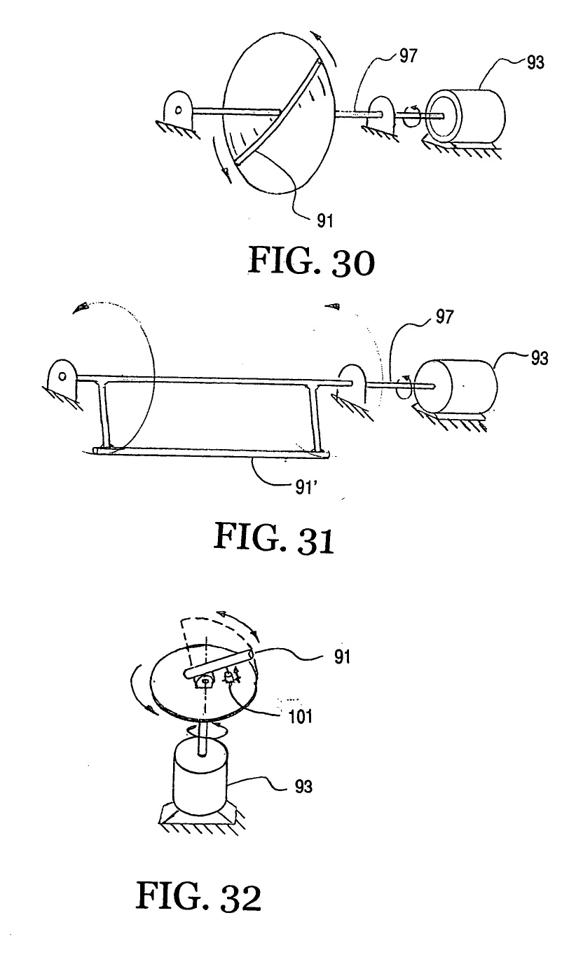

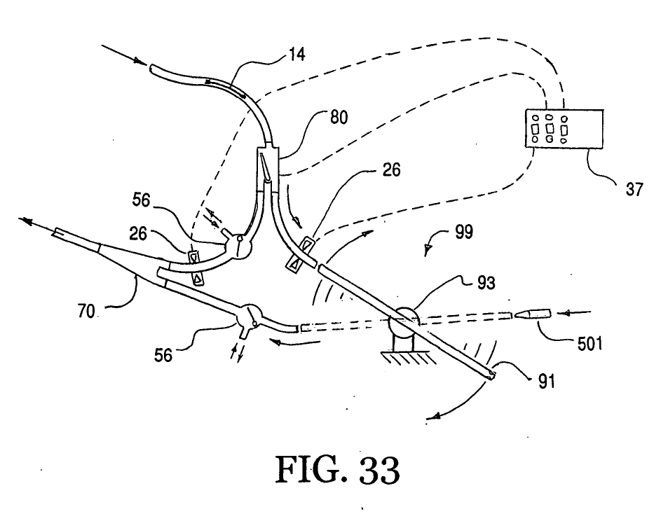

With reference to FIGS. 30 through 32, various embodiments of the spinner device are disclosed. FIG. 30 discloses a radial spinner in which a drive shaft 97 extending from a variable speed motor 93 rotates a glow stick holding tube 91 about an axis intersecting the glow stick. FIG. 31 discloses a cylindrical spinner in which a glow stick holding tube 91′ is spun about an axis such that the glow stick is held parallel to the rotational axis. FIG. 32 discloses a variable spinner device in which the glow stick holding tube 91 is supported for rotation about two axes; one axis perpendicular to the motor axis and one axis parallel to the motor axis such that the glow stick holding tube 91 may be reoriented to a variety of positions by an actuator 101 as it is spun by the motor.

In operation a spinning device 99 is signaled to start spinning when a photo-electric switch 26 or functionally mechanical switch senses the entry of a glow stick 14 into the spinner device 99. The controller 37 will then send a signal to motor 93 causing the drive shaft to rotate for a given period of time at desired speeds. The time and speed are adjustable via control 37. The spinner device 99 will stop and then realign with the tubular member 12 as the motor is a stepper motor and the exact position of the drive shaft is known at all times. For example, if the tubular exit member 12 is located at 25 degrees, the controller 37 will instruct the stepper motor 93 to spin its cycle and then stop at 25 degrees. Alternatively, a solenoid extends a plunger to engage and mate with notch on the spinner which is in alignment with the tubular exit member 12.

With reference to FIG. 2, the system 10 also includes a pulsing pressure system 100 which may be employed when incompressible fluids are utilized in conjunction with the propulsion system 16. The pulsing pressure system 100 will pulse the glow sticks 14 through the system 10 to match a desired frequency. Such may be employed where one is trying to match or choreograph the movements with other parameters, for example, music tracks.

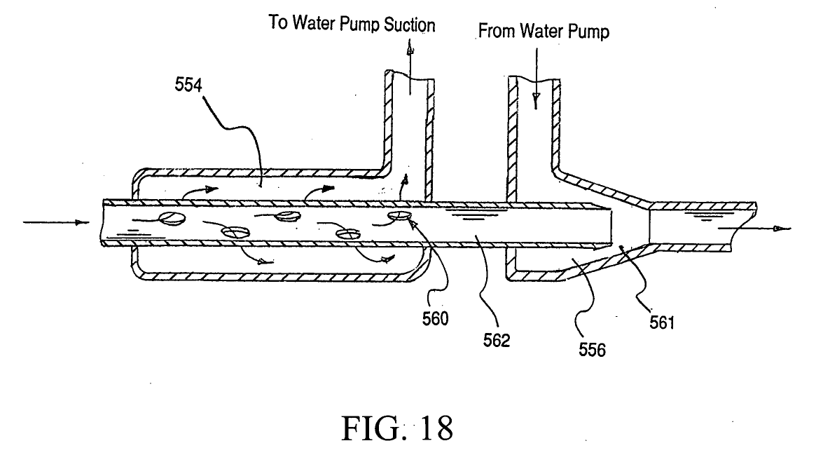

When using incompressible fluids in accordance with the present invention, the same basic main propulsion system 46 and device components 32, 70, 80 and 74 may be utilized. Due to fluids incompressible properties, however, a simpler booster system is employed. As described below with reference to FIG. 18, water and other incompressible fluids have disadvantages which include added system weight, travel speed, and pressure losses due to piping friction. The advantages include allowing precise glow stick travel and allowing for a simpler booster system with less glow stick impact wear.

In accordance with this variation, the glow stick is conveyed around the loop by fluid pressure based upon momentum built up in the traveling fluid this is similar to a stick carried by water flowing down a stream. The fluid propulsion system is placed in the system 10 by the loading device 34 and high pressure fluid entering valve 556 propels the glow stick around the loop. Valve 554, the fluid return valve, guides the glow stick straight through the valve while allowing the fluid to exit through various side ports (560). The water then returns to the pump suction. The glow stick travels between valve 554 and valve 556 in chamber 562. The valve 556 is constructed to induce a negative pressure in chamber 562 containing the glow stick using a venturi affect at throat area 561. Once the glow stick reaches the venturi throat area 561 of valve 556, it is induced into the discharge line by the high velocity of the fluid stream. Once past the valve area 556, the glow stick is propelled around the loop as before. In accordance with this embodiment, reversing of the valve function is not required.

Efforts for reduction of friction losses are important to be able to improve performance when using incompressible fluids. Friction reductions maybe further accomplished by the addition of fluid additives as well as utilization of alternate low friction materials.

While the preferred embodiments have been shown and described, it will be understood that there is no intent to limit the invention by such disclosure, but rather, is intended to cover all modifications and alternate constructions falling within the spirit and scope of the invention.

1. A lighting system, comprising:
an elongated tubular member;
an illuminating member positioned within the tubular member for movement therein;
propulsion means associated with the tubular member causing the illuminating member to move within tubular member.

2. The lighting system according to claim 1, wherein the illuminating member is a glow stick.

3. The lighting system according to claim 2, wherein the glow stick includes a seal.

4. The lighting system according to claim 2, wherein the glow stick includes a protective sleeve.

5. The lighting system according to claim 1, wherein the illuminating member is an electrically powered device.

6. The lighting system according to claim 1, wherein a plurality of illuminating members are positioned within the tubular member.

7. The lighting system according to claim 1, wherein the propulsion means includes compressible and incompressible fluids.

8. The lighting system according to claim 7, wherein the propulsion means includes an air compressor linked to the tubular member.

9. The lighting system according to claim 1, wherein the propulsion means includes a booster system with a first valve and a second valve.

10. The lighting system according to claim 9, wherein the first and second valves are check valves.

11. The lighting system according to claim 9, wherein the first and second valves are ball valves.

12. The lighting system according to claim 9, wherein the first valve and the second valve are selectively linked to a pressure source.

13. The lighting system according to claim 12, wherein the first valve and second valve selective switch between functioning as an exhaust port and a high pressure port.

14. The lighting system according to claim 1, further including a loading device for inserting illuminating devices within the tubular member.

15. The lighting system according to claim 1, further including a removing device for removing illuminating devices from the tubular member.

16. The lighting system according to claim 1, further including a splitting device for switching between sections of the tubular member.

17. The lighting system according to claim 1, further including a joining member for linking sections of the tubular member.

18. The lighting system according to claim 1, further including a spinner device for spinning the illuminating member.

19. The lighting system according to claim 1, further including a brake system for controlling speed of the illuminating members.

20. The lighting system according to claim 1, further including a control assembly.
